(19) United States
(12) Patent Application Publication
(10) Pub. No.: US 2013/0134681 A1
(43) Pub. Date: May 30, 2013

(54) CHECK MARK ON MOLDED PART OF AN IN-MOLD ASSEMBLY

(71) Applicants: Toan Cong Ho, La Habra, CA (US); Richard Vitai Huynh, Markham (CA); Mark Francis Buchanan, Arthur (CA)

(72) Inventors: Toan Cong Ho, La Habra, CA (US); Richard Vitai Huynh, Markham (CA); Mark Francis Buchanan, Arthur (CA)

(21) Appl. No.: 13/497,430

(22) PCT Filed: Sep. 20, 2010
(86) PCT No.: PCT/CA2010/001523

§ 371 Date: Dec. 13, 2012

Related U.S. Application Data
(60) Provisional application No. 61/277,151, filed on Sep. 21, 2009.

(51) Int. Cl. B29C 31/08

(52) U.S. Cl. CPC B29C 31/085
USPC 277/590; 264/40.5

(57) ABSTRACT

A method is provided for manufacturing an assembly including a plurality of extrusions and a molded part. having a mold mark. The method includes the steps of: placing the plurality of extrusions into a mold; molding the molded part of the plurality of extrusions to form the assembly; forming the mold mark on the molded part at the joint line between the molded part and at least one of the plurality of extrusions; and detecting the presence of the mold mark at the joint line to determine whether the assembly has formed at the correct size.

### BACKGROUND

1. Field of the Invention

The invention relates to a method for manufacturing a seal assembly. More particularly, the invention relates to a method that utilizes a mold mark to allow an operator to visually determine whether a seal assembly is formed at a correct size.

2. Summary

According to one aspect of the invention, a method for manufacturing an assembly including a plurality of extrusions and a molded part having a mold mark includes the steps of: placing the plurality of extrusions into a mold; molding the molded part to the plurality of extrusions to form the assembly; forming the mold mark on the molded part at a joint line between the molded part and at least one of the plurality of extrusions; and detecting the presence of the mold mark at the joint line to determine whether the assembly has been formed at the correct size.

According to yet another aspect of the invention, a seal assembly includes a plurality of extrusions and a molded part. The molded part is molded between two of the plurality of extrusions to connect one of the plurality of extrusions to another one of the plurality of extrusions. The molded part terminates at a joint line and includes a mold mark formed at the joint line wherein the presence of the mold mark indicates that the seal assembly has been formed at a correct size and is suitable for use.

### BRIEF DESCRIPTION OF THE DRAWINGS

The invention will be readily appreciated as the same becomes better understood by reference to the following detailed description when considered in connection with the accompanying drawings wherein:

FIG. 1 is a side view of a seal assembly according to one embodiment including a plurality of extrusions secured to one another by molded parts;

FIG. 2 is a side view of the seal assembly including the molded part having a mold mark at a joint line between the molded part and one of the plurality of extrusions; and

FIG. 3 is a flow chart depicting a method of manufacturing an assembly according to another embodiment.

### DETAILED DESCRIPTION OF THE EMBODIMENTS

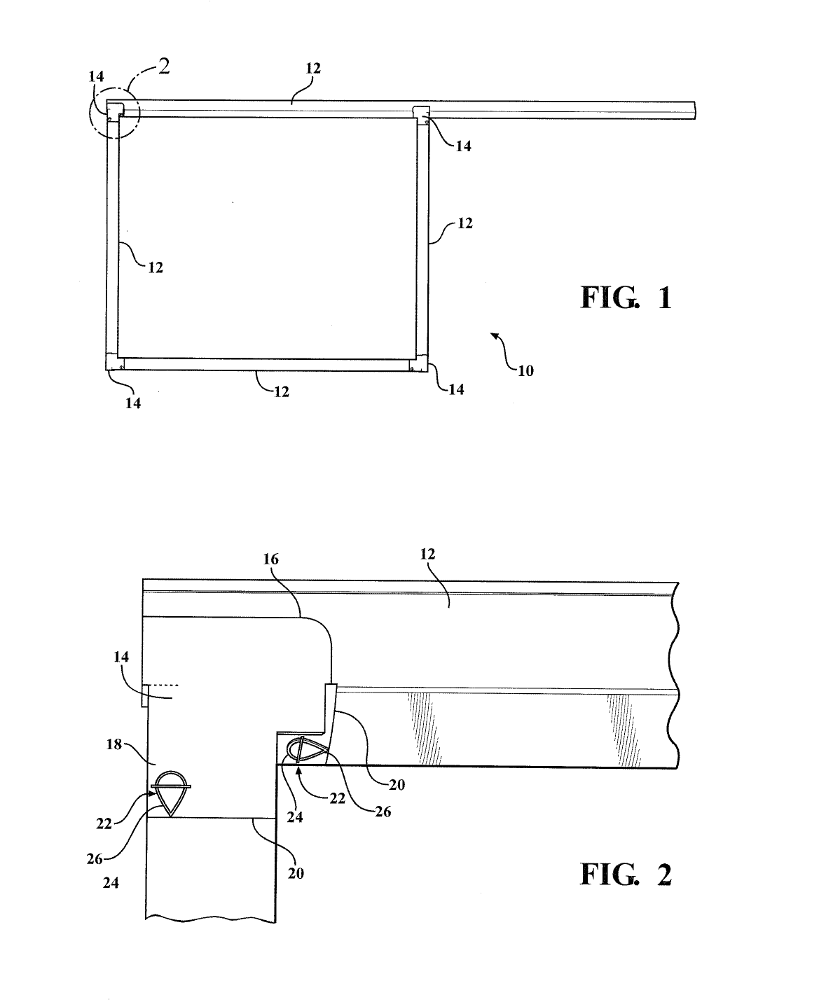

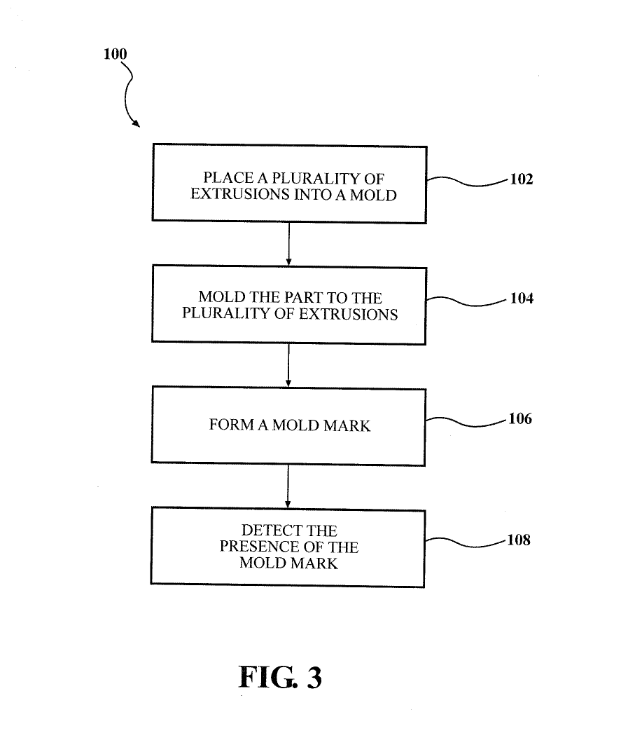

Referring to FIGS. 1 and 2, an assembly, generally shown at 10, includes a plurality of extrusions 12 connected to one another by at least one molded part 14. It is appreciated that the assembly 10 could be utilized for any of numerous applications, and may include extrusions 12 and molded parts 14 of any of numerous shapes and sizes. In one embodiment, the assembly 10 is a seal assembly designed for a rear window of a pick-up truck.

The molded part 14 in the seal assembly 10 in one embodiment may be a corner piece having a first segment 16 and a second segment 18. The first segment 16 may be a generally horizontal segment and the second segment 18 may be a generally vertical segment. Each of the first 16 and second 18 segments includes a joint line 20 at each location where the molded part 14 is joined to one of the plurality of extrusions 12.

A mold mark, generally indicated at 22, is positioned on each molded part 14 proximate the joint line 20 of at least one of the first 16 and second 18 segments. In one embodiment, the mold mark 22 is generally teardrop-shaped and has a rounded end 24 and an opposing pointed end 26. The pointed end 26 terminates at the joint line 20. It is appreciated that the particular shape and location of the mold mark 22 may vary so long as the mold mark 22 is positioned at or near the joint line 20.

The mold mark 22 allows an operator to make a quick and easy visual determination of whether the seal assembly 10 has been formed at the correct size. If the operator detects the entire mold mark 22, including the pointed end 26, at the joint line 20 where the molded part 14 meets one of the plurality of extrusions 12, then the operator knows that the molded part 14 has been fully formed and that the seal assembly 10 has been formed at the correct size. The pointed end 26 of the mold mark 22 makes it particularly easy for the operator to visually determine whether the molded part 14 has been fully formed.

On the other hand, if the operator detects that the entire mold mark 22 is not present on the molded part 14, that is, the pointed end 26 is not visible on the molded part 14 at the joint line 20 between the molded part 14 and one of the plurality of extrusions 12, then the molded part 14 has not been fully formed. Therefore, the operator knows that the seal assembly 10 is the incorrect size and should be discarded.

The presence of the pointed end 26 of the mold mark 22 at the joint line 20 allows the operator to make an easy visual determination of the suitability of the seal assembly 10. As a result, the mold mark 22 in this embodiment eliminates the need for the operator to take the additional step of measuring the seal assembly 10 before attaching the seal assembly 10 to the pick-up truck.

A method of manufacturing the assembly 10 according to one embodiment is generally shown at 100. The method of manufacturing 100 includes a step 102 of placing the plurality of extrusions 12 in a mold, a step 104 of molding the molded part 14 to the plurality of extrusions 12 to form the assembly 10, a step 106 of forming the mold mark 22 on the molded part 14 at the joint line 20 between the molded part 14 and at least one of the plurality of extrusions 12; and a step 108 of detecting the presence of the mold mark 22 at the joint line 20 to determine whether the assembly 10 has been formed at the correct size. If the entire mold mark 22 is present on the molded part 14 after the assembly 10 has been removed from the mold, the assembly 10 has been formed at the correct size and may be installed. If the entire mold mark 22 has not been formed, then the molded part 14 has not been fully formed. Therefore, the operator knows that the assembly 10 is the incorrect size and should be discarded. As mentioned above, the mold mark 22 allows an operator to make a quick and easy visual determination of whether the assembly 10 has been formed at the correct size.

The invention has been described in an illustrative manner. It is to be understood that the terminology, which has been used, is intended to be in the nature of words of description rather than of limitation. Many modifications and variations of the invention are possible in light of the above teachings. Therefore, within the scope of the appended claims, the invention may be practiced other than as specifically described.

What is claimed:

1. A method for manufacturing an assembly including a plurality of extrusions and a molded part having a mold mark, the method comprising the steps of:
placing the plurality of extrusions into a mold;
molding the molded part to the plurality of extrusions to form the assembly;
forming the mold mark on the molded part at a joint line between the molded part and at least one of the plurality of extrusions; and
detecting the presence of the mold mark at the joint line to determine whether the assembly has been formed at the correct size.

2. The method as set forth in claim 1 including the step of removing the assembly from the mold prior to the step of detecting the presence of the mold mark at the joint line to determine whether the assembly has been formed at the correct size.

3. The method as set forth in claim 2 wherein the step of molding the molded part to the plurality of extrusions to form the assembly includes the step of injecting a moldable material into the mold.

4. A seal assembly comprising:
a plurality of extrusions; and
a molded part molded between two of said plurality of extrusions to connect one of said plurality of extrusions to another one of said plurality of extrusions, said molded part terminating at a joint line and including a mold mark formed at said joint line wherein the presence of said mold mark indicates that said seal assembly has been formed at a correct size and is suitable for use.

5. The seal assembly as set forth in claim 4 wherein said mold mark has a pointed end.

6. The seal assembly as set forth in claim 4 wherein said mold mark is generally teardrop-shaped.

7. The seal assembly as set forth in claim 4 wherein said molded part includes a generally horizontal segment and a generally vertical segment each terminating at said joint line and abutting one of the plurality of extrusions.
